(19) United States
(12) Patent Application Publication
(10) Pub. No.: US 2023/0271449 A1
(43) Pub. Date: Aug. 31, 2023

(54) METHOD FOR PRODUCING TIRE RUBBER COMPOSITION, TIRE RUBBER COMPOSITION, AND PNEUMATIC TIRE

(71) Applicant: Toyo Tire Corporation, Itami-shi (JP)

(72) Inventor: Ayana Uchida, Itami-shi (JP)

(73) Assignee: Toyo Tire Corporation, Itami-shi (JP)

(21) Appl. No.: 17/978,294

(22) Filed: Nov. 1, 2022

(30) Foreign Application Priority Data
Nov. 18, 2021 (JP) 2021-187804

(51) Int. Cl. B60C 1/00; C08L 9/06; C08F 8/04; C08K 3/36; C08K 3/06

(52) U.S. Cl. CPC B60C 1/0016; B60C 1/0025; C08F 8/04; C08K 3/06; C08K 3/36; C08L 9/06

(57) ABSTRACT

A method is disclosed for producing a tire rubber composition containing silica, a crosslinking compounding ingredient, and a rubber component containing 70 mass% to 100 mass% of a hydrogenated copolymer. The method includes hydrogenating an aromatic vinyl-conjugated diene copolymer, having a weight average molecular weight of 300,000 or more as measured by gel permeation chromatography, and having a hydrogenation rate of a conjugated diene moiety of 80 mol% or more. The method incudes: a first step of mixing 50 mass% to 95 mass% of 100 mass% of the hydrogenated copolymer with a total amount of the silica; a second step of mixing a rest of the hydrogenated copolymer with a mixture obtained in the first step; and a third step of mixing the crosslinking compounding ingredient with a mixture obtained in the second step.

### BACKGROUND OF THE INVENTION

### 1. Field of the Invention

The present invention relates to a method for producing a tire rubber composition, a tire rubber composition, and a pneumatic tire.

### 2. Description of the Related Art

In recent years, in response to heightened environmental awareness, a reduction in rolling resistance of a pneumatic tire has been demanded in order to lower a fuel cost of an automobile.

As a method for producing a rubber composition that reduces rolling resistance, JP-A-2016-151018 (Patent Literature 1) and JP-A-2016-125018 (Patent Literature 2) describe a method of dividedly adding a filler, and JP-A-2016-125016 (Patent Literature 3) and JP-A-2016-125013 (Patent Literature 4) describe a method of dividedly adding a rubber component and a filler.

### SUMMARY OF THE INVENTION

However, the rubber compositions described in Patent Literatures 1 to 4 all contain an ordinary diene rubber as a main component, and there is room for improvement in rolling resistance and abrasion resistance of the rubber composition containing a hydrogenated copolymer as a main component.

In view of the above points, an object of the invention is to provide a method for producing a tire rubber composition, which is excellent in low fuel cost while maintaining or improving abrasion resistance, a tire rubber composition, and a pneumatic tire.

In order to solve the problems, a method for producing a tire rubber composition according to the invention is a method for producing a tire rubber composition containing silica, a crosslinking compounding ingredient, and a rubber component containing 70 mass% to 100 mass% of a hydrogenated copolymer which is obtained by hydrogenating an aromatic vinyl-conjugated diene copolymer, has a weight average molecular weight of 300,000 or more as measured by gel permeation chromatography, and has a hydrogenation rate of a conjugated diene moiety of 80 mol% or more, and the method includes: a first step of mixing 50 mass% to 95 mass% of 100 mass% of the hydrogenated copolymer with a total amount of the silica; a second step of mixing a rest of the hydrogenated copolymer with a mixture obtained in the first step; and a third step of mixing the crosslinking compounding ingredient with a mixture obtained in the second step.

A discharge temperature in the first step may be 120° C. to 160° C., and a discharge temperature in the second step may be 120° C. to 160° C.

A tire rubber composition according to the invention is obtained by the above production method.

A pneumatic tire according to the invention is prepared using the above tire rubber composition.

According to the production method of the invention, it is possible to provide a tire rubber composition, which is excellent in low fuel cost while maintaining or improving abrasion resistance, and a pneumatic tire.

### DESCRIPTION OF EMBODIMENTS

Hereinafter, matters related to embodiments of the invention will be described in detail.

A method for producing a tire rubber composition according to the present embodiment is a method for producing a tire rubber composition containing silica, a crosslinking compounding ingredient, and a rubber component containing 70 mass% to 100 mass% of a hydrogenated copolymer which is obtained by hydrogenating an aromatic vinyl-conjugated diene copolymer, has a weight average molecular weight of 300,000 or more as measured by gel permeation chromatography, and has a hydrogenation rate of a conjugated diene moiety of 80 mol% or more, and the method incudes: a first step of mixing 50 mass% to 95 mass% of 100 mass% of the hydrogenated copolymer with a total amount of the silica; a second step of mixing a rest of the hydrogenated copolymer with a mixture obtained in the first step; and a third step of mixing the crosslinking compounding ingredient with a mixture obtained in the second step.

The method for producing a tire rubber composition according to the present embodiment can be carried out using a normally used internal kneader such as a Banbury mixer.

In the first step, 50 mass% to 95 mass% of 100 mass% of the hydrogenated copolymer, a total amount of the silica, and compounding ingredients other than the crosslinking compounding ingredient are added, and the mixture is kneaded while raising a temperature of the mixture.

A ratio of the hydrogenated copolymer to be compounded in the first step is not particularly limited as long as it is 50 mass% to 95 mass% of 100 mass% of the hydrogenated copolymer, and is preferably 60 mass% to 90 mass%.

A discharge temperature in the first step is not particularly limited, and is preferably 120° C. to 160° C.

In the second step, a rest of the hydrogenated copolymer is mixed. A discharge temperature in the second step is not particularly limited, and is preferably 120° C. to 160° C.

When rubber components other than the hydrogenated copolymer are contained, the rubber components other than the hydrogenated copolymer are preferably kneaded in the first step, and a part or all of the rubber components other than the hydrogenated copolymer may be kneaded in the second step with the scope not departing from the object of the invention.

When the silica and compounding ingredients other than the crosslinking compounding ingredient are compounded, these compounding ingredients are preferably kneaded in the first step, and may be kneaded in the second step with the scope not departing from the object of the invention.

In the third step, the crosslinking compounding ingredient is added to the mixture obtained in the second step and kneaded. A discharge temperature at this time is not particularly limited, and is preferably 80° C. to 120° C., and more preferably 90° C. to 110° C.

The rubber component used in the method for producing a tire rubber composition according to the present embodiment contains a hydrogenated copolymer obtained by hydrogenating an aromatic vinyl-conjugated diene copolymer, having a weight average molecular weight of 300,000 or more as measured by a gel permeation chromatography, and having a hydrogenation rate of a conjugated diene moiety of 80 mol% or more. Here, in this specification, the “weight average molecular weight as measured by gel permeation chromatography (GPC)” is a value calculated in terms of polystyrene using a differential refractive index detector (RI) as a detector, using tetrahydrofuran (THF) as a solvent, and using commercially available standard polystyrene at a measurement temperature of 40° C., a flow rate of 1.0 mL/min, a concentration of 1.0 g/L, and an injection amount of 40 µL. In addition, the hydrogenation rate is a value calculated based on a spectrum reduction rate of an unsaturated bond moiety in a spectrum obtained by H¹-NMR measurement.

An aromatic vinyl constituting the aromatic vinyl-conjugated diene copolymer is not particularly limited, and examples thereof include styrene, α-methylstyrene, 1-vinylnaphthalene, 3-vinyltoluene, ethylvinylbenzene, divinylbenzene, 4-cyclohexylstyrene, and 2,4,6-trimethylstyrene. These may be used alone or in combination of two or more thereof.

A conjugated diene constituting the aromatic vinyl-conjugated diene copolymer is not particularly limited, and examples thereof include 1,3-butadiene, isoprene, 1,3-pentadiene, 2,3-dimethylbutadiene, 2-phenyl-1,3-butadiene, and 1,3-hexadiene. These may be used alone or in combination of two or more thereof.

The aromatic vinyl-conjugated diene copolymer is not particularly limited, and is preferably a copolymer of styrene and 1,3-butadiene (styrene-butadiene copolymer). Therefore, the hydrogenated copolymer is preferably a hydrogenated styrene-butadiene copolymer. In addition, the hydrogenated copolymer may be a random copolymer, a block copolymer, or an alternating copolymer.

The hydrogenated copolymer can be synthesized, for example, by synthesizing the aromatic vinyl-conjugated diene copolymer and performing a hydrogenation treatment. A method for synthesizing the aromatic vinyl-conjugated diene copolymer is not particularly limited, and examples thereof include a solution polymerization method, a gas phase polymerization method, and a bulk polymerization method. A solution polymerization method is particularly preferred. In addition, a polymerization type may be either a batch type or a continuous type. A commercially available aromatic vinyl-conjugated diene copolymer can also be used.

A hydrogenation method is not particularly limited, and hydrogenation may be performed by a known method under known conditions. Usually, hydrogenation is carried out at 20° C. to 150° C. under a hydrogen pressure of 0.1 MPa to 10 MPa in the presence of a hydrogenation catalyst. The hydrogenation rate can be selected freely by changing an amount of the hydrogenation catalyst, a hydrogen pressure during a hydrogenation reaction, a reaction time, and the like. As the hydrogenation catalyst, a compound containing any one of metals of Groups 4 to 11 in the periodic table can be generally used. For example, a compound containing Ti, V, Co, Ni, Zr, Ru, Rh, Pd, Hf, Re, or Pt atoms can be used as the hydrogenation catalyst. More specific examples of the hydrogenation catalyst include: a metallocene compound containing Ti, Zr, Hf, Co, Ni, Pd, Pt, Ru, Rh, or Re; a supported heterogeneous catalyst in which a metal such as Pd, Ni, Pt, Rh, or Ru is supported on a carrier such as carbon, silica, alumina, or diatomaceous earth; a homogeneous Ziegler catalyst in which an organic salt or an acetylacetone salt of a metallic element such as Ni or Co is combined with a reducing agent such as organic aluminum; an organometallic compound or complex containing Ru or Rh; and a fullerene or carbon nanotube in which hydrogen is occluded.

The hydrogenation rate of the hydrogenated copolymer (ratio of hydrogenation to the conjugated diene moiety in the aromatic vinyl-conjugated diene copolymer) is 80 mol% or more, preferably 80 mol% to 95 mol%, more preferably 85 mol% to 95 mol%, and still more preferably 90 mol% to 95 mol%. When the hydrogenation rate is 80 mol% or more, an effect of improving abrasion resistance by homogenizing crosslinking is excellent.

The weight average molecular weight of the hydrogenated copolymer is not particularly limited as long as it is 300,000 or more, and is preferably 300,000 to 2,000,000, more preferably 300,000 to 1,000,000, and still more preferably 300,000 to 600,000.

The rubber component may contain a diene rubber other than the hydrogenated copolymer, and examples of the diene rubber include a natural rubber (NR), an isoprene rubber (IR), a butadiene rubber (BR), a styrene-butadiene rubber (SBR), a styrene-isoprene copolymer rubber, a butadiene-isoprene copolymer rubber, and a styrene-isoprene-butadiene copolymer rubber. In addition, the diene rubber as a copolymer may be an alternating copolymer, a block copolymer, or a random copolymer. These solid rubbers may be used alone or in a blend of two or more thereof.

A compounding ratio of the hydrogenated copolymer in the rubber component is preferably 70 mass% to 100 mass%, and more preferably 80 mass% to 100 mass%.

As a reinforcing filler, silica is contained, or carbon black may be used in combination. That is, the reinforcing filler may be silica alone or a combination of carbon black and silica. The combination of carbon black and silica is preferred. A compounding amount of the reinforcing filler is not particularly limited, and for example, is preferably 10 parts by mass to 150 parts by mass, more preferably 20 parts by mass to 100 parts by mass, and still more preferably 30 parts by mass to 80 parts by mass, with respect to 100 parts by mass of the rubber component.

The silica is not particularly limited, and wet silica such as silica made by a wet-type precipitation method or silica made by a wet-type gel-method is preferably used. A compounding amount of the silica is preferably 10 parts by mass to 150 parts by mass, and more preferably 15 parts by mass to 100 parts by mass, with respect to 100 parts by mass of the rubber component from a viewpoint of balance with tan δ or reinforcing properties of the rubber.

In addition to the silica, a silane coupling agent such as sulfide silane or mercapto silane may be further compounded. When a silane coupling agent is added, a compounding amount of the silane coupling agent is preferably 2 mass%, to 20 mass% with respect to a compounding amount of the silica.

The carbon black is not particularly limited, and various known kinds of products can be used. A compounding amount of the carbon black is preferably 1 part by mass to 70 parts by mass, and more preferably 1 part by mass to 30 parts by mass, with respect to 100 parts by mass of the rubber component.

Examples of the crosslinking compounding ingredient include a vulcanization agent or a vulcanization accelerator. Examples of the vulcanization agent include sulfur components such as powdered sulfur, precipitated sulfur, colloidal sulfur, insoluble sulfur, and highly dispersible sulfur. A compounding amount of the crosslinking compounding ingredient is not particularly limited, and is preferably 0.1 parts by mass to 4 parts by mass, and more preferably 0.2 parts by mass to 3 part by mass, with respect to 100 parts by mass of the rubber component.

Examples of the vulcanization accelerator include a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamate-based vulcanization accelerator, and among these, the sulfenamide-based vulcanization accelerator, dithiocarbamate-based vulcanization accelerator, and guanidine-based vulcanization accelerators are preferred. In addition, two or more kinds of these vulcanization accelerators may be used in combination. For example, it is preferable to use the dithiocarbamate-based vulcanization accelerator and the guanidine-based vulcanization accelerator in combination, and in this case, a compounding ratio (guanidine-based vulcanization accelerator/dithiocarbamate-based vulcanization accelerator) is preferably 0.5 to 4.0 in mass ratio.

Examples of the sulfenamide-based vulcanization accelerator include N-cyclohexyl-2-benzothiazolylsulfenamide (CZ), N-tert-butyl-2-benzothiazolylsulfenamide (NS), N-oxidiethylene-2-benzothiazolylsulfenamide (OBS), and N,N-diisopropyl-2-benzothiazolesulfenamide (DZ).

Examples of the guanidine-based vulcanization accelerator include 1,3-diphenylguanidine (D) and di-O-tolylguanidine (DT).

Examples of the dithiocarbamate-based vulcanization accelerator include zinc dibenzyldithiocarbamate (ZnBzDTC), zinc dimethyldithiocarbamate (ZnMDC), zinc diethyldithiocarbamate (ZnEDC), zinc di-n-butyldithiocarbamate (ZnBDC), zinc N-pentamethylenedithiocarbamate (ZnPDC), zinc ethylphenyldithiocarbamate (ZnEPDC), sodium dimethyldithiocarbamate (NaMDC), sodium diethyldithiocarbamate (NaEDC), sodium di-n-butyldithiocarbamate (NaBDC), tellurium diethyldithiocarbamate (TeEDC), copper dimethyldithiocarbamate (CuMDC), and iron dimethyldithiocarbamate (FeMDC).

A compounding amount of the sulfenamide-based vulcanization accelerator is not particularly limited, and is preferably 0.1 parts by mass to 3 parts by mass, and more preferably 0.2 parts by mass to 3 parts by mass, with respect to 100 parts by mass of the rubber component.

A compounding amount of the guanidine-based vulcanization accelerator is not particularly limited, and is preferably 0.1 parts by mass to 3 parts by mass, and more preferably 0.2 parts by mass to 3 parts by mass, with respect to 100 parts by mass of the rubber component.

A compounding amount of the dithiocarbamate-based vulcanization accelerator is not particularly limited, and is preferably 0.1 parts by mass to 3 parts by mass, and more preferably 0.2 parts by mass to 3 parts by mass, with respect to 100 parts by mass of the rubber component.

A compounding amount of the vulcanization accelerator (when two or more kinds of vulcanization accelerators are compounded, refers to a total amount of the vulcanization accelerators) is preferably 0.1 parts by mass to 7 parts by mass, and more preferably 0.5 parts by mass to 5 parts by mass, with respect to 100 parts by mass of the rubber component.

As compounding ingredients other than the crosslinking compounding ingredient, compounding chemicals such as a reinforcing filler, a process oil, a processing aid, zinc oxide, stearic acid, a softener, a plasticizer, a resin, a wax, and an antiaging agent, which are generally used in the rubber industry, can be appropriately compounded within a normal range.

A rubber composition obtained by the production method according to the present embodiment can be used for a tire, and can be applied to various parts of a tire such as a tread and sidewalls of a pneumatic tire having various applications and sizes, such as a tire for a passenger vehicle, or a large-sized tire for a truck or a bus. The rubber composition can be molded into a predetermined shape by an ordinary method, for example, extrusion processing, combined with other parts, and then subjected to vulcanization molding at, for example, 140° C. to 180° C. to produce a pneumatic tire.

A type of the pneumatic tire according to the present embodiment is not particularly limited, and examples thereof include various types of tires such as a tire for a passenger vehicle, and a heavy-duty tire for a truck or a bus.

### Impossible and Impractical Circumstances

The invention is characterized in that in the first step, the hydrogenated copolymer is compounded with the total amount of the silica in a predetermined ratio, and in the second step, a mixture obtained in the first step is mixed with the rest of the hydrogenated copolymer. An effect of the invention is due to a microscopic difference in a dispersion state caused by the characteristics of the production steps, and the microscopic difference in the dispersion state cannot be distinguished by commonly used indicators such as composition and properties. Therefore, it can be said that in the invention, it is almost impractical to “directly specify the object by structure or characteristics thereof at the time of filing”.

### EXAMPLES

Hereinafter, Examples of the invention will be illustrated, but the invention is not limited to these Examples.

### Synthesis Example of Hydrogenated Copolymer

Into a heat-resistant reaction vessel subjected to nitrogen substitution, 2.5 L of cyclohexane, 50 g of tetrahydrofuran (THF), 0.12 g of n-butyllithium, 100 g of styrene, and 400 g of 1,3-butadiene were charged, and polymerized at a reaction temperature of 50° C. After the polymerization was completed, 1.7 g of N,N-bis(trimethylsilyl) aminopropylmethyldiethoxysilane was added and allowed to react for 1 hour, then hydrogen gas was supplied at a pressure of 0.4 MPa-gauge, and the mixture was stirred for 20 minutes. Next, the hydrogen gas supply pressure was set to 0.7 MPa-gauge, the reaction temperature was set to 90° C., and a catalyst mainly composed of titanocene dichloride was used to react until a target hydrogenation rate was reached. The solvent was removed to obtain a hydrogenated copolymer.

A weight average molecular weight of the obtained hydrogenated copolymer was measured using “LC-10A” manufactured by Shimadzu Corporation as a measuring device, “PLgel-MIXED-C” manufactured by Polymer Laboratories Ltd. as a column, a differential refractive index detector (RI) as a detector, and THF as a solvent, under a measurement temperature of 40° C., a flow rate of 1.0 mL/min, a concentration of 1.0 g/L, and an injection amount of 40 µL, and was 350,000 in terms of polystyrene based on standard polystyrene. A bound styrene content was 20 mass%, and a hydrogenation rate of a butadiene moiety was 90 mol%. The bound styrene content was obtained based on a spectrum intensity ratio between protons based on a styrene unit and protons based on a butadiene unit (including the hydrogenated moiety) using H¹-NMR.

### Examples and Comparative Examples

According to compounding (part by mass) shown in Table 1 below, using a Banbury mixer, first, in a first step, components other than a vulcanization accelerator and sulfur were added and kneaded (discharge temperature = 160° C.), and a rest of a hydrogenated copolymer was added to the obtained mixture for kneading (discharge temperature = 160° C.). In a third step, the vulcanization accelerator and the sulfur were added to and mixed with the obtained mixture (discharge temperature = 90° C.) to prepare a rubber composition.

Details of each component in Table 1 are as follows.
SBR: “HPR350” manufactured by JSR Corporation
Hydrogenated SBR: hydrogenated copolymer prepared according to the synthesis example
Silica: “Ultrasil VN3” manufactured by Evonik Japan Co., Ltd.
Silane coupling agent: “Si69” manufactured by Evonik Japan Co., Ltd.
Carbon black: “SEAST 3” manufactured by Tokai Carbon Co., Ltd.
Aromatic oil: “Process NC140” manufactured by JXTG Energy Corporation
Zinc oxide: “Zinc oxide No. 2” manufactured by Mitsui Mining & Smelting Co., Ltd.
Antiaging agent: “Antigen 6C” manufactured by Sumitomo Chemical Co., Ltd.
Stearic acid: “LUNAC S-20” manufactured by Kao Corporation
Wax: “OZOACE0355” manufactured by NIPPON SEIRO CO., LTD.
Vulcanization accelerator 1: sulfenamide-based vulcanization accelerator, “SOXINOL CZ” manufactured by Sumitomo Chemical Co., Ltd.
Vulcanization accelerator 2: guanidine-based vulcanization accelerator, “NOCCELER D” manufactured by OUCHI SHINKO CHEMICAL INDUSTRIAL CO., LTD.
Vulcanization accelerator 3: dithiocarbamate-based vulcanization accelerator “SANCELER ZBE” manufactured by SANSHIN CHEMICAL INDUSTRY CO., LTD.
Sulfur: “Fine powdered sulfur” manufactured by Tsurumi Chemical Industry Co., ltd.

Low fuel cost performance and abrasion resistance were evaluated for each of the obtained rubber compositions. Evaluation method is as follows.

Low fuel cost performance: conforms to JIS K6394. That is, a test piece vulcanized at 160° C. for 30 minutes was measured for a loss factor tan δ under conditions of a temperature of 60° C., a static strain of 10%, a dynamic strain of 2%, and a frequency of 10 Hz using a viscoelasticity tester manufactured by Toyo Seiki Co., Ltd. Regarding a reciprocal of tan δ, in Comparative Example 2, the reciprocal of tan δ was shown by an index obtained by taking a value of Comparative Example 1 as 100, and in Examples 1 to 5 and Comparative Example 4, each reciprocal of tan δ was shown by an index obtained by taking a value of Comparative Example 3 as 100. It is evaluated that a smaller index indicates smaller tan δ and more excellent low fuel cost.

Abrasion resistance: conforms to JIS K6264. An abrasion loss was measured under conditions of a load of 40 N and a slip ratio of 30% using a Lambourn abrasion tester manufactured by Iwamoto Seisakusho Co., Ltd. Regarding a reciprocal of the abrasion loss, in Comparative Example 2, a reciprocal of the abrasion loss was shown by an index obtained by taking a value of Comparative Example 1 as 100, and in Examples 1 to 5 and Comparative Example 4, a reciprocal of each abrasion loss was shown by an index obtained by taking a value of Comparative Example 3 as 100. It is evaluated that a larger index indicates more excellent abrasion resistance.

TABLE 1

| | | Comparative Example 1 | Comparative Example 2 | Comparative Example 3 | Example 1 | Example 2 | Example 3 | Example 4 | Example 5 | Comparative Example 4 |
|---|---|---|---|---|---|---|---|---|---|---|
| First step | SBR | 100 | 80 | - | - | - | - | - | - | - |
| | Hydrogenated SBR | - | - | 100 | 90 | 80 | 70 | 60 | 50 | 40 |
| | Silica | 70 | 70 | 70 | 70 | 70 | 70 | 70 | 70 | 70 |
| | Silane coupling agent | 4 | 4 | 4 | 4 | 4 | 4 | 4 | 4 | 4 |
| | Carbon black | 5 | 5 | 5 | 5 | 5 | 5 | 5 | 5 | 5 |
| | Aromatic oil | 30 | 30 | 30 | 30 | 30 | 30 | 30 | 30 | 30 |
| | Zinc oxide | 2.0 | 2.0 | 2.0 | 2.0 | 2.0 | 2.0 | 2.0 | 2.0 | 2.0 |
| | Antiaging agent | 2.0 | 2.0 | 2.0 | 2.0 | 2.0 | 2.0 | 2.0 | 2.0 | 2.0 |
| | Stearic acid | 2.0 | 2.0 | 2.0 | 2.0 | 2.0 | 2.0 | 2.0 | 2.0 | 2.0 |
| | Wax | 2.0 | 2.0 | 2.0 | 2.0 | 2.0 | 2.0 | 2.0 | 2.0 | 2.0 |
| Second step | SBR | - | 20 | - | - | - | - | - | - | - |
| | Hydrogenated SBR | - | - | - | 10 | 20 | 30 | 40 | 50 | 60 |
| Third step | Vulcanization accelerator 1 | 0.5 | 0.5 | 0.5 | 0.5 | 0.5 | 0.5 | 0.5 | 0.5 | 0.5 |
| | Vulcanization accelerator 2 | 1.0 | 1.0 | 1.0 | 1.0 | 1.0 | 1.0 | 1.0 | 1.0 | 1.0 |
| | Vulcanization accelerator 3 | 0.8 | 0.8 | 0.8 | 0.8 | 0.8 | 0.8 | 0.8 | 0.8 | 0.8 |
| | Sulfur | 1.6 | 1.6 | 1.6 | 1.6 | 1.6 | 1.6 | 1.6 | 1.6 | 1.6 |
| Low fuel cost | | 100 | 105 | 100 | 96 | 94 | 90 | 92 | 94 | 105 |
| Abrasion resistance | | 100 | 83 | 100 | 110 | 109 | 107 | 104 | 100 | 95 |

Results are as shown in Table 1. Comparing Comparative Example 1 with Comparative Example 2, in the compounding in which the styrene-butadiene rubber (SBR) is used as the rubber component, when the rubber component is dividedly added in the first step and the second step, the low fuel cost and the abrasion resistance deteriorate.

Comparing Examples 1 to 5 with Comparative Example 3, in the compounding in which the hydrogenated SBR is used as the rubber component, when the rubber component is dividedly added in the first step and the second step at a predetermined ratio, the low fuel cost is improved while maintaining or improving the abrasion resistance.

Comparing Comparative Example 3 with Comparative Example 4, in the compounding in which the hydrogenated SBR is used as the rubber component, when the rubber component is dividedly added in the first step and the second step at a ratio outside a predetermined range, the low fuel cost and the abrasion resistance deteriorate.

With the method for producing a tire rubber composition according to the invention, it is possible to produce a rubber composition that can be used for various tires of a passenger vehicle, a light truck, or a bus.

What is claimed is:

1. A method for producing a tire rubber composition containing silica, a crosslinking compounding ingredient, and a rubber component containing 70 mass% to 100 mass% of a hydrogenated copolymer which is obtained by hydrogenating an aromatic vinyl-conjugated diene copolymer, has a weight average molecular weight of 300,000 or more as measured by gel permeation chromatography, and has a hydrogenation rate of a conjugated diene moiety of 80 mol% or more, the method comprising:
a first step of mixing 50 mass% to 95 mass% of 100 mass% of the hydrogenated copolymer with a total amount of the silica;
a second step of mixing a rest of the hydrogenated copolymer with a mixture obtained in the first step; and
a third step of mixing the crosslinking compounding ingredient with a mixture obtained in the second step.

2. The method for producing a tire rubber composition according to claim 1, wherein
a discharge temperature in the first step is 120° C. to 160° C., and
a discharge temperature in the second step is 120° C. to 160° C.

3. A tire rubber composition, which is obtained by the production method according to claim 1.

4. A tire rubber composition, which is obtained by the production method according to claim 2.

5. A pneumatic tire, which is prepared using the tire rubber composition according to claim 3.

6. A pneumatic tire, which is prepared using the tire rubber composition according to claim 4.
